(19) United States
(12) Patent Application Publication
(10) Pub. No.: US 2021/0350246 A1
(43) Pub. Date: Nov. 11, 2021

(54) ALTERING MOTION OF COMPUTER SIMULATION CHARACTERS TO ACCOUNT FOR SIMULATION FORCES IMPOSED ON THE CHARACTERS

(71) Applicant: Sony Interactive Entertainment Inc., Tokyo (JP)

(72) Inventors: Michael Taylor, San Mateo, CA (US); Glenn Black, San Mateo, CA (US)

(21) Appl. No.: 16/871,861

(22) Filed: May 11, 2020

(51) Int. Cl. G06N 3/10; G06N 3/04; G06N 3/08

(52) U.S. Cl. CPC G06N 3/10; G06N 3/088; G06N 3/0454

(57) ABSTRACT

The reaction to randomized forces that are imposed on a ragdoll computer simulation character are learned by a neural network such as a generative adversarial network (GAN) as the forces are applied to the character and the character attempts to return to an initial character configuration.

### FIELD

The present application relates to technically inventive, non-routine solutions that are necessarily rooted in computer technology and that produce concrete technical improvements.

### BACKGROUND

Computer simulations such as computer games attempt to animate characters to match as closely as possible humans in equivalent real-world situations.

### SUMMARY

Present principles are directed to animating computer simulation characters to respond to forces applied to the characters in a way that realistically mimics how a human would respond to equivalent forces.

Present principles understand that reaction time and body part conservation may be variable during movement simulation and reactions to outside forces. A neural network may be used to learn reactions to forces, and as the NN is trained, randomized forces can be applied to one or more computer game characters and the reaction of the characters noted and fed back to further train the NN. For example, a character may simply cover his head in response to a shove. The NN learns to react with learning every force. Ground truth can be an initial character configuration and the character is caused to attempt to return to the initial configuration. In effect the NN learns how a character reacts in a manner that one would learn by pushing a motion capture (MOCAP) human character.

A reward function can be maximized, and a body part prioritized in modeling reaction to forces. A variable reaction to external forces may be learned based on a sliding scale of consciousness using domain randomization. Feedback data may be delayed to simulate reduced reaction time. To model reaction to a force, the maximum strength of one or more joints of the character may be increased or decreased. Involuntary movements in reaction to forces may be simulated by playing forward control system. The safety of different body parts or objects may be prioritized based on reward feedback.

Accordingly, in one aspect an apparatus includes at least one processor programmed with instructions which are executable by the at least one processor to emulate plural randomized forces on a ragdoll character in a computer simulation, and animate the ragdoll to move in accordance with the randomized forces.

In example embodiments the instructions may be executable to cause the character to attempt to regain a configuration of the character prior to imposition of an emulated force on the character. The instructions may be executable to delay feedback of results of emulating a force on the character to simulate reduced reaction ability of the character, and/or to change a simulated strength of at least one joint of the character responsive to emulating a force on the character. Still further, example non-limiting instructions can be executable to simulate an involuntary movement of the character responsive to emulating a force on the character.

In some examples the instructions are executable to execute at least one neural network to learn reactions of the character to external forces. The neural network may include a generative adversarial network (GAN).

A computer simulation console and/or a computer server may implement the processor. In another aspect, an assembly includes a processor programmed with instructions executable to configure the processor to train at least one neural network (NN) to learn reactions of a computer character to forces applied to the character at least in part by simulating one or more forces against the character in an initial configuration, causing the character to attempt to return to the initial configuration, and feeding back to the NN reactions of the character to simulated forces against the character.

In another aspect, a method includes applying randomized simulated forces to a character of computer simulation. The method also includes learning how the character reacts to the forces by causing the character to attempt to regain an initial configuration the character was in prior to imposition of a simulated force on the character, and then animating the character responsive to simulated forces applied to the character in accordance with the learning.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 illustrates example logic in example flow chart format for imposing randomized forces on a “rag doll” character;

FIG. 3 illustrates example logic in example flow chart format for training a neural network to emulate force on a character;

FIG. 4 illustrates force being applied to a ragdoll character;

FIG. 5 further illustrates example logic in example flow chart format for training a neural network to emulate force on a character; and

FIG. 6 illustrates an example generative adversarial network (GAN) that may be used consistent with present principles.

### DETAILED DESCRIPTION

This disclosure relates generally to computer ecosystems including aspects of consumer electronics (CE) device networks such as but not limited to computer game networks. A system herein may include server and client components, connected over a network such that data may be exchanged between the client and server components. The client components may include one or more computing devices including game consoles such as Sony PlayStation® or a game console made by Microsoft or Nintendo or other manufacturer, virtual reality (VR) headsets, augmented reality (AR) headsets, portable televisions (e.g. smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple Computer or Google. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may include one or more processors executing instructions that configure the servers to receive and transmit data over a network such as the Internet. Or, a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website to network members.

As used herein, instructions refer to computer-implemented steps for processing information in the system. Instructions can be implemented in software, firmware or hardware and include any type of programmed step undertaken by components of the system.

A processor may be any conventional general-purpose single- or multi-chip processor that can execute logic by means of various lines such as address lines, data lines, and control lines and registers and shift registers.

Software modules described by way of the flow charts and user interfaces herein can include various sub-routines, procedures, etc. Without limiting the disclosure, logic stated to be executed by a particular module can be redistributed to other software modules and/or combined together in a single module and/or made available in a shareable library.

Present principles described herein can be implemented as hardware, software, firmware, or combinations thereof; hence, illustrative components, blocks, modules, circuits, and steps are set forth in terms of their functionality.

Further to what has been alluded to above, logical blocks, modules, and circuits described below can be implemented or performed with a general-purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

The functions and methods described below, when implemented in software, can be written in an appropriate language such as but not limited to Java, C# or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires. Such connections may include wireless communication connections including infrared and radio.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

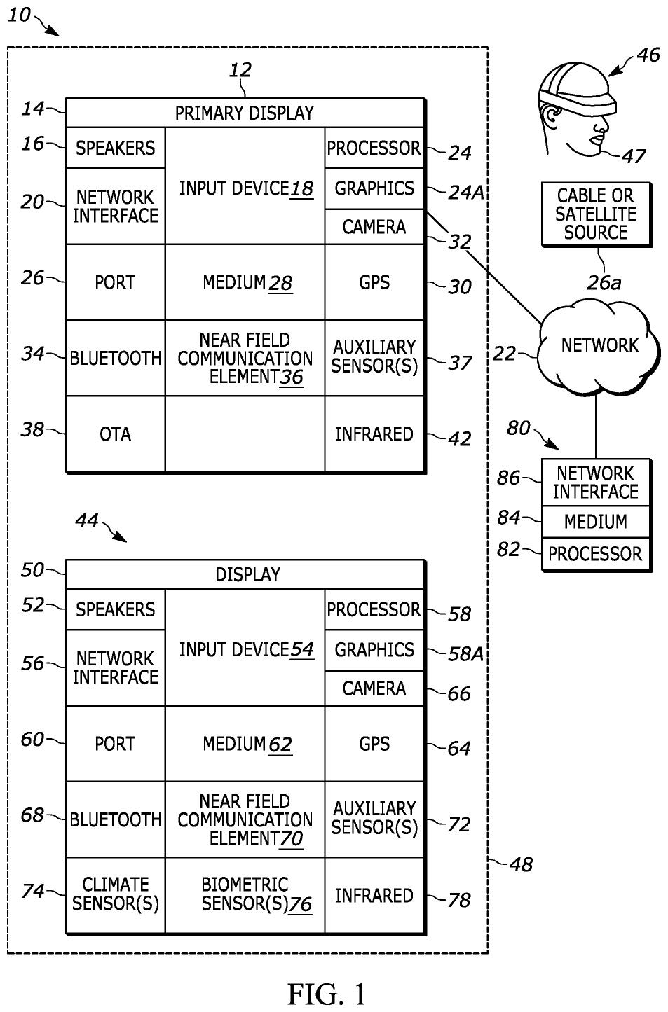

Now specifically referring to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to an Internet-enabled TV with a TV tuner (equivalently, set top box controlling a TV). However, the AVD 12 alternatively may be an appliance or household item, e.g. computerized Internet enabled refrigerator, washer, or dryer. The AVD 12 alternatively may also be a computerized Internet enabled (“smart”) telephone, a tablet computer, a notebook computer, a wearable computerized device such as e.g. computerized Internet-enabled watch, a computerized Internet-enabled bracelet, other computerized Internet-enabled devices, a computerized Internet-enabled music player, computerized Internet-enabled head phones, a computerized Internet-enabled implantable device such as an implantable skin device, etc. Regardless, it is to be understood that the AVD 12 is configured to undertake present principles (e.g. communicate with other CE devices to undertake present principles, execute the logic described herein, and perform any other functions and/or operations described herein).

Accordingly, to undertake such principles the AVD 12 can be established by some or all of the components shown in FIG. 1. For example, the AVD 12 can include one or more displays 14 that may be implemented by a high definition or ultra-high definition “4K” or higher flat screen and that may be touch-enabled for receiving user input signals via touches on the display. The AVD 12 may include one or more speakers 16 for outputting audio in accordance with present principles, and at least one additional input device 18 such as e.g. an audio receiver/microphone for e.g. entering audible commands to the AVD 12 to control the AVD 12. The example AVD 12 may also include one or more network interfaces 20 for communication over at least one network 22 such as the Internet, an WAN, an LAN, etc. under control of one or more processors 24 including. A graphics processor 24A may also be included. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as e.g. controlling the display 14 to present images thereon and receiving input therefrom. Furthermore, note the network interface 20 may be, e.g., a wired or wireless modem or router, or other appropriate interface such as, e.g., a wireless telephony transceiver, or Wi-Fi transceiver as mentioned above, etc.

In addition to the foregoing, the AVD 12 may also include one or more input ports 26 such as, e.g., a high definition multimedia interface (HDMI) port or a USB port to physically connect (e.g. using a wired connection) to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be, e.g., a separate or integrated set top box, or a satellite receiver. Or, the source 26a may be a game console or disk player containing content that might be regarded by a user as a favorite for channel assignation purposes described further below. The source 26a when implemented as a game console may include some or all of the components described below in relation to the CE device 44.

The AVD 12 may further include one or more computer memories 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media. Also, in some embodiments, the AVD 12 can include a position or location receiver such as but not limited to a cellphone receiver, GPS receiver and/or altimeter 30 that is configured to e.g. receive geographic position information from at least one satellite or cellphone tower and provide the information to the processor 24 and/or determine an altitude at which the AVD 12 is disposed in conjunction with the processor 24. However, it is to be understood that another suitable position receiver other than a cellphone receiver, GPS receiver and/or altimeter may be used in accordance with present principles to e.g. determine the location of the AVD 12 in e.g. all three dimensions.

Continuing the description of the AVD 12, in some embodiments the AVD 12 may include one or more cameras 32 that may be, e.g., a thermal imaging camera, a digital camera such as a webcam, and/or a camera integrated into the AVD 12 and controllable by the processor 24 to gather pictures/images and/or video in accordance with present principles. Also included on the AVD 12 may be a Bluetooth transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 37 (e.g., a motion sensor such as an accelerometer, gyroscope, cyclometer, or a magnetic sensor, an infrared (IR) sensor, an optical sensor, a speed and/or cadence sensor, a gesture sensor (e.g. for sensing gesture command), etc.) providing input to the processor 24. The AVD 12 may include an over-the-air TV broadcast port 38 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12.

Still referring to FIG. 1, in addition to the AVD 12, the system 10 may include one or more other CE device types. In one example, a first CE device 44 may be used to send computer game audio and video to the AVD 12 via commands sent directly to the AVD 12 and/or through the below-described server while a second CE device 46 may include similar components as the first CE device 44. In the example shown, the second CE device 46 may be configured as a VR headset worn by a player 47 as shown. In the example shown, only two CE devices 44, 46 are shown, it being understood that fewer or greater devices may be used.

In the example shown, to illustrate present principles all three devices 12, 44, 46 are assumed to be members of an entertainment network in, e.g., a home, or at least to be present in proximity to each other in a location such as a house. However, present principles are not limited to a particular location, illustrated by dashed lines 48, unless explicitly claimed otherwise.

The example non-limiting first CE device 44 may be established by any one of the above-mentioned devices, for example, a portable wireless laptop computer or notebook computer or game controller (also referred to as “console”), and accordingly may have one or more of the components described below. The first CE device 44 may be a remote control (RC) for, e.g., issuing AV play and pause commands to the AVD 12, or it may be a more sophisticated device such as a tablet computer, a game controller communicating via wired or wireless link with the AVD 12, a personal computer, a wireless telephone, etc.

Accordingly, the first CE device 44 may include one or more displays 50 that may be touch-enabled for receiving user input signals via touches on the display. The first CE device 44 may include one or more speakers 52 for outputting audio in accordance with present principles, and at least one additional input device 54 such as e.g. an audio receiver/microphone for e.g. entering audible commands to the first CE device 44 to control the device 44. The example first CE device 44 may also include one or more network interfaces 56 for communication over the network 22 under control of one or more CE device processors 58. A graphics processor 58A may also be included. Thus, the interface 56 may be, without limitation, a Wi-Fi transceiver, which is an example of a wireless computer network interface, including mesh network interfaces. It is to be understood that the processor 58 controls the first CE device 44 to undertake present principles, including the other elements of the first CE device 44 described herein such as e.g. controlling the display 50 to present images thereon and receiving input therefrom. Furthermore, note the network interface 56 may be, e.g., a wired or wireless modem or router, or other appropriate interface such as, e.g., a wireless telephony transceiver, or Wi-Fi transceiver as mentioned above, etc.

In addition to the foregoing, the first CE device 44 may also include one or more input ports 60 such as, e.g., a HDMI port or a USB port to physically connect (e.g. using a wired connection) to another CE device and/or a headphone port to connect headphones to the first CE device 44 for presentation of audio from the first CE device 44 to a user through the headphones. The first CE device 44 may further include one or more tangible computer readable storage medium 62 such as disk-based or solid-state storage. Also in some embodiments, the first CE device 44 can include a position or location receiver such as but not limited to a cellphone and/or GPS receiver and/or altimeter 64 that is configured to e.g. receive geographic position information from at least one satellite and/or cell tower, using triangulation, and provide the information to the CE device processor 58 and/or determine an altitude at which the first CE device 44 is disposed in conjunction with the CE device processor 58. However, it is to be understood that another suitable position receiver other than a cellphone and/or GPS receiver and/or altimeter may be used in accordance with present principles to e.g. determine the location of the first CE device 44 in e.g. all three dimensions.

Continuing the description of the first CE device 44, in some embodiments the first CE device 44 may include one or more cameras 66 that may be, e.g., a thermal imaging camera, a digital camera such as a webcam, and/or a camera integrated into the first CE device 44 and controllable by the CE device processor 58 to gather pictures/images and/or video in accordance with present principles. Also included on the first CE device 44 may be a Bluetooth transceiver 68 and other Near Field Communication (NFC) element 70 for communication with other devices using Bluetooth and/or NFC technology, respectively. An example NFC element can be a radio frequency identification (RFID) element.

Further still, the first CE device 44 may include one or more auxiliary sensors 72 (e.g., a motion sensor such as an accelerometer, gyroscope, cyclometer, or a magnetic sensor, an infrared (IR) sensor, an optical sensor, a speed and/or cadence sensor, a gesture sensor (e.g. for sensing gesture command), etc.) providing input to the CE device processor 58. The first CE device 44 may include still other sensors such as e.g. one or more climate sensors 74 (e.g. barometers, humidity sensors, wind sensors, light sensors, temperature sensors, etc.) and/or one or more biometric sensors 76 providing input to the CE device processor 58. In addition to the foregoing, it is noted that in some embodiments the first CE device 44 may also include an infrared (IR) transmitter and/or IR receiver and/or IR transceiver 78 such as an IR data association (IRDA) device. A battery (not shown) may be provided for powering the first CE device 44. The CE device 44 may communicate with the AVD 12 through any of the above-described communication modes and related components.

The second CE device 46 may include some or all of the components shown for the CE device 44. Either one or both CE devices may be powered by one or more batteries.

Now in reference to the afore-mentioned at least one server 80, it includes at least one server processor 82, at least one tangible computer readable storage medium 84 such as disk-based or solid-state storage, and at least one network interface 86 that, under control of the server processor 82, allows for communication with the other devices of FIG. 1 over the network 22, and indeed may facilitate communication between servers and client devices in accordance with present principles. Note that the network interface 86 may be, e.g., a wired or wireless modem or router, Wi-Fi transceiver, or other appropriate interface such as, e.g., a wireless telephony transceiver.

Accordingly, in some embodiments the server 80 may be an Internet server or an entire server “farm” and may include and perform “cloud” functions such that the devices of the system 10 may access a “cloud” environment via the server 80 in example embodiments for, e.g., network gaming applications. Or, the server 80 may be implemented by one or more game consoles or other computers in the same room as the other devices shown in FIG. 1 or nearby.

The methods herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may be embodied in a non-transitory device such as a CD ROM or Flash drive. The software code instructions may alternatively be embodied in a transitory arrangement such as a radio or optical signal, or via a download over the Internet.

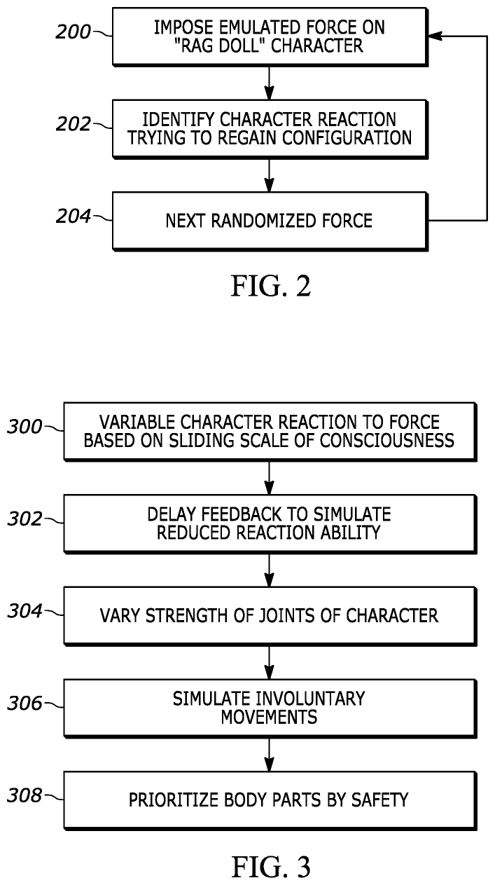

FIG. 2 illustrates logic in non-limiting flow chart form of imposing simulated forces on “ragdoll” computer characters. “Ragdoll” refers to a physics engine which treats a character as a collection of rigid bones tied together by constraints that restrict how the bones move relative to each other. A computer simulation character may, for example, die or be injured, and the emulated body motion is in accordance with the constraints.

Commencing at block 200, an emulated force is imposed on a computer simulation character such as a video game character the movements of which are established by a physics engine executed by the game processor. As mentioned above, in an example implementation ragdoll physics are used to animate the motion of characters.

At block 202 the reaction of the character to the force imposed at block 200 is identified and recorded. Typically, the physics engine will cause the character to react to a force by attempting to re-assume the configuration the character had just prior to imposition of the force. Block 204 indicates that another, different force is randomly selected and then the logic loops back to block 200 to apply the force to the character. In this way the effect on the character of a large number of forces established at random and applied against the character according to the physics engine of the simulation are observed and used to train a machine learning algorithm such as one or more neural networks (NN) such as a generative adversarial network (GAN). During subsequent game play the machine learning algorithm alters the configurations of characters in response to simulated game forces according to its learning.

FIG. 3 illustrates additional logic. Commencing at block 300, variable character reactions to forces are recorded based on imposing a sliding scale of “consciousness” on the character. For example, a character simulated to be completely unconscious may be simulated to react to a force as much as the physics engine allows, while a semi-conscious character may be modeled to resist reacting to the force at a minimal level and a fully conscious character may be modeled to resist reacting to the force at a higher level. This may be implemented by increasing joint and limb rigidity/strength with increasing consciousness and/or reducing the magnitude of the physics engine-driven reactions. In this way the manner in which a conscious “heroic” character reacts to a particular force may be made to differ from the reaction of an unconscious character.

Proceeding to block 302, force reaction may be further emulated by delaying feedback of a character's reaction to simulate reduced reaction ability. Block 304 indicates that consistent with the above, the strength of joints affected by an imposed force may be varied to vary the recorded reaction of the character to the force. Involuntary movements a character might make in response to a force may be simulated at block 306. An example of this would be a tap to the knee causing the foot to involuntarily kick up. Block 308 indicates that the character may be modeled to prioritize body parts for safety. For example, for concussive forces a conscious character might cover its head with it arms.

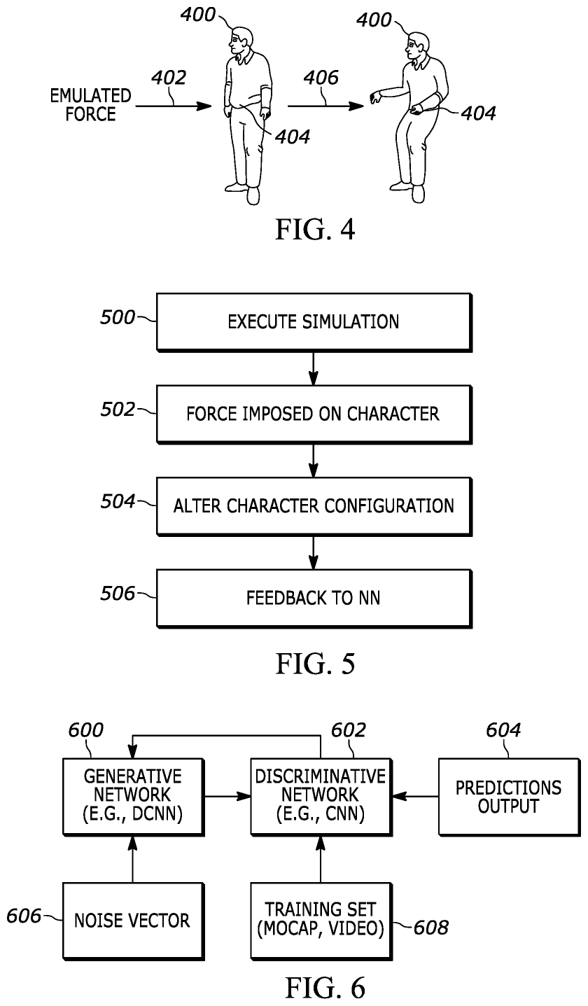

FIG. 4 illustrates. A computer simulation character 400 such as a video game character may have a force 402 imposed on a part of the character 400, in the example shown, the torso 404. In response as illustrated by the arrow 406 the torso 404 distorts in accordance with the game physics engine.

Turn now to FIG. 5. A computer simulation may be executed at block 500. During play of the simulation a force may be imposed on a simulation character at block 502. Moving to block 504, the simulation processor executing the machine learning algorithm alters the character configuration in reaction to the force according to the learning of the algorithm. The reaction may be fed back at block 506 to the machine learning algorithm to further refine its learning.

FIG. 6 illustrates an example GAN that may be used as a machine learning algorithm in accordance with present principles. The GAN includes a generative network 600 that may be implemented in non-limiting examples by a deconvolutional neural network (DCNN). The generative network 600 feeds data to a discriminative network 602 that may be implemented by a convolutional NN (CNN). In essence the generative network 600 attempts to fool the discriminative network 602, which outputs predictions 604 and feeds the predictions back to the generative network 600. Noise vectors 606 may be input to the generative network 600 while a training set 608 of ground truth human body reactions to imposed forces as established from videos of real-world humans including humans wearing motion capture (MOCAP) apparatus.

While particular techniques and machines are herein shown and described in detail, it is to be understood that the subject matter which is encompassed by the present invention is limited only by the claims.

What is claimed is:

1. An apparatus comprising:
at least one processor programmed with instructions which are executable by the at least one processor to:
emulate plural randomized forces on a ragdoll character in a computer simulation; and
animate the ragdoll to move in accordance with the randomized forces.

2. The apparatus of claim 1, wherein the instructions are executable to:
cause the character to attempt to regain a configuration of the character prior to imposition of an emulated force on the character.

3. The apparatus of claim 1, wherein the instructions are executable to:
delay feedback of results of emulating a force on the character to simulate reduced reaction ability of the character.

4. The apparatus of claim 1, wherein the instructions are executable to:
change a simulated strength of at least one joint of the character responsive to emulating a force on the character.

5. The apparatus of claim 1, wherein the instructions are executable to:
simulate an involuntary movement of the character responsive to emulating a force on the character.

6. The apparatus of claim 1, wherein the instructions are executable to:
execute at least one neural network to learn reactions of the character to external forces.

7. The apparatus of claim 6, wherein the neural network comprises a generative adversarial network (GAN).

8. The apparatus of claim 1, comprising a computer simulation console implementing the processor.

9. The apparatus of claim 1, comprising a computer server implementing the processor.

10. An assembly comprising:
a processor programmed with instructions executable to configure the processor to:
train at least one neural network (NN) to learn reactions of a computer character to forces applied to the character at least in part by:
simulating one or more forces against the character in an initial configuration;
causing the character to attempt to return to the initial configuration; and
feeding back to the NN reactions of the character to simulated forces against the character.

11. The assembly of claim 10, wherein the instructions are executable to:
maximize at least one reward function in modeling reaction of the character to forces.

12. The assembly of claim 10, wherein the instructions are executable to:
animate the character using ragdoll physics.

13. The assembly of claim 10, wherein the instructions are executable to:
learn a variable reaction to external forces based on a sliding scale of consciousness using domain randomization.

14. The assembly of claim 10, wherein the instructions are executable to:
delay feedback to the NN to simulate reduced reaction time.

15. The assembly of claim 10, wherein the instructions are executable to:
alter a strength of at least one joint of the character responsive to model reaction to a simulated force applied against the character.

16. The assembly of claim 10, wherein the instructions are executable to:
simulate an involuntary movement of the character responsive to emulating a force on the character.

17. The assembly of claim 10, wherein the neural network comprises a generative adversarial network (GAN).

18. A method comprising:
applying randomized simulated forces to a character of computer simulation;
learning how the character reacts to the forces by causing the character to attempt to regain an initial configuration the character was in prior to imposition of a simulated force on the character; and
animating the character responsive to simulated forces applied to the character in accordance with the learning.

19. The method of claim 18, wherein the character is animated using ragdoll physics.

20. The method of claim 18, wherein the learning is implemented using at least one generative adversarial network (GAN).
